(19) United States
(12) Patent Application Publication
(10) Pub. No.: US 2018/0342077 A1
(43) Pub. Date: Nov. 29, 2018

(54) TEACHER DATA GENERATION APPARATUS AND METHOD, AND OBJECT DETECTION SYSTEM

(71) Applicant: FUJITSU LIMITED, Kawasaki-shi (JP)

(72) Inventors: Naoyuki TSUNO, Inagi (JP); Hiroshi Okano, Hachioji (JP)

(73) Assignee: FUJITSU LIMITED, Kawasaki-shi (JP)

(21) Appl. No.: 15/949,638

(22) Filed: Apr. 10, 2018

(30) Foreign Application Priority Data
May 26, 2017 (JP) 2017-104493

(51) Int. Cl. G06T 7/70

(52) U.S. Cl. CPC G06T 7/70; G06T 2207/10004; G06T 2207/20081

(57) ABSTRACT

A teacher data generation apparatus configured to generate teacher data used for object detection for detecting a specific identifying target includes a processor configured to execute a process including learning the specific identifying target by an object recognition method using reference data including the specific identifying target to generate an identification model of the specific identifying target and detecting the specific identifying target from moving image data including the specific identifying target based on deduction by the object recognition method using the generated identification model to generate teacher data for the specific identifying target.

### CROSS-REFERENCE TO RELATED APPLICATION

This application is based upon and claims the benefit of priority of the prior Japanese Patent Application No. 2017-104493, filed on May 26, 2017, the entire contents of which are incorporated herein by reference.

### FIELD

The embodiments discussed herein are related to a teacher data generation apparatus, a teacher data generation method, and an object detection system.

### BACKGROUND

In recent years, deep learning has been used to perform object detection for detecting identifying targets appearing in images. An example of the method for recognizing objects by deep learning is Faster R-CNN (Regions-Convolutional Neural Network) (see, for example, S. Ren, K. He, R. Girshick, and J. Sun, “Faster R-CNN: Towards Real-Time Object Detection with Region Proposal Networks”, Jan. 6, 2016, [online], <https://arxiv.org./pdf/1506.01497.pdf>). Another example is SSD (Single Shot multibox Detector) (see, for example, W. Liu, D. Anguelov, D. Erhan, C. Szegedy, and S. E. Reed, “SSD: Single Shot Multibox Detector”, Dec. 29, 2016, [online], <https://arxiv.org./pdf/1512.02325.pdf>).

In the method for recognizing objects by deep learning, it is necessary to previously determine and define the identifying targets. Further, in deep learning, it is said that generalization typically requires teacher data including about 1,000 or more images to be prepared for 1 kind of an identifying target.

For generation of teacher data images, there are a method of collecting still images in which identifying targets appear, and a method of extracting still image data from moving image data in which identifying targets appear for image conversion of the moving image data into still image data. Of these methods, the image conversion method of converting moving image data into still image data is preferable in view of efforts and time taken to obtain an enormous number of still images.

Teacher data are generated by cutting out the regions of the identifying targets appearing in the obtained still images and affixing labels to the cut-out still images, or by generating information files containing regions and labels and combining the information files with still images.

Hitherto, the image conversion process of converting moving image data into still image data for each identifying target and the information affixing process of affixing regions and labels to the still images have all been manually done by human operators. Therefore, a lot of efforts and time have been taken for generation of teacher data.

Hence, for example, there has been proposed a method of inputting, at a detection phase of an object detection system, a large number of data to a model generated at a learning phase of the object detection system, to thereby enable reduction of efforts and time taken to affix labels to training images (see, for example, Japanese Laid-open Patent Publication No. 2016-62524).

There has also been proposed a method of selecting an object identification device for a previously prepared individual object from recognition results of a general-purpose object identification device and using it to improve recognition accuracy, to thereby enable reduction of efforts and time taken to affix labels to moving images (see, for example, Japanese Laid-open Patent Publication No. 2013-12163).

In, for example, R-CNN (Regions-Convolutional Neural Network), which is an object recognition method by deep learning, there has been reported a method of adjusting an image region to a required size, in order that there is no need for taking into consideration, the size and aspect ratio of an image region from which it is desired to detect an object (see, for example, Y. Jia, E. Shelhamer, J. Donahue, S. Karayev, J. Long, R. Girshick, S. Guadarrama and T. Darrell, “Gaffe: Convolutional Architecture for Fast Feature Embedding”, Jun. 20, 2014, [online], <https://arxiv.org./pdf/1408.5093.pdf>).

### SUMMARY

According to one aspect of the present disclosure, a teacher data generation apparatus configured to generate teacher data used for object detection for detecting a specific identifying target includes: an identification model generation part configured to learn a specific identifying target by an object recognition method using reference data including the specific identifying target to generate an identification model of the specific identifying target; and a teacher data generation part configured to detect the specific identifying target from moving image data including the specific identifying target based on deduction by the object recognition method using the generated identification model to generate teacher data for the specific identifying target.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware configuration of a teacher data generation apparatus of the present disclosure;

FIG. 2 is a block diagram illustrating an example of an entire teacher data generation apparatus of the present disclosure;

FIG. 3 is a flowchart illustrating an example of a flow of processes of an entire teacher data generation apparatus of the present disclosure;

FIG. 4 is a block diagram illustrating an example of an existing teacher data generation apparatus;

FIG. 5 is a block diagram illustrating another example of an existing teacher data generation apparatus;

FIG. 6 is a block diagram illustrating an example of processes of the respective parts in an entire teacher data generation apparatus of embodiment 1;

FIG. 7 is a flowchart illustrating an example of a flow of processes of the respective parts in an entire teacher data generation apparatus of embodiment 1;

FIG. 8 is a diagram illustrating an example of a label in an XML file of reference data of an identification model generation part of a teacher data generation apparatus of embodiment 1;

FIG. 9 is a diagram illustrating an example of a Python import file defining the label of FIG. 8;

FIG. 10 is a diagram illustrating an example of the Python import file of FIG. 9 that is configured to be referable by Faster R-CNN;

FIG. 11 is a block diagram illustrating an example of processes of the respective parts in an entire teacher data generation apparatus of embodiment 2;

FIG. 12 is a flowchart illustrating an example of a flow of processes of the respective parts in an entire teacher data generation apparatus of embodiment 2;

FIG. 13 is a diagram illustrating an example of a moving image data table of embodiment 2;

FIG. 14 is a block diagram illustrating an example of processes of the respective parts in an entire teacher data generation apparatus of embodiment 3;

FIG. 15 is a flowchart illustrating an example of a flow of processes of the respective parts in an entire teacher data generation apparatus of embodiment 3;

FIG. 16 is a block diagram illustrating an example of an entire object detection system of the present disclosure;

FIG. 17 is a flowchart illustrating an example of a flow of processes of an entire object detection system of the present disclosure;

FIG. 18 is a block diagram illustrating another example of an entire object detection system of the present disclosure;

FIG. 19 is a block diagram illustrating an example of an entire training part of an object detection system of the present disclosure;

FIG. 20 is a block diagram illustrating another example of an entire training part of an object detection system of the present disclosure;

FIG. 21 is a flowchart illustrating an example of a flow of processes of an entire training part of an object detection system of the present disclosure;

FIG. 22 is a block diagram illustrating an example of an entire deduction part of an object detection system of the present disclosure;

FIG. 23 is a block diagram illustrating another example of an entire deduction part of an object detection system of the present disclosure; and

FIG. 24 is a flowchart illustrating an example of a flow of processes of an entire deduction part of an object detection system of the present disclosure.

### DESCRIPTION OF EMBODIMENTS

For example, according to the description in Y. Jia, E. Shelhamer, J. Donahue, S. Karayev, J. Long, R. Girshick, S. Guadarrama and T. Darrell, “Gaffe: Convolutional Architecture for Fast Feature Embedding”, Jun. 20, 2014, fonlinet<https://arxiv.org./pdf/1408.5093.pdf>, it is possible to solve the problem to be solved by the invention described in S. Ren, K. He, R. Girshick, and J. Sun, “Faster R-CNN: Towards Real-Time Object Detection with Region Proposal Networks”, Jan. 6, 2016, [online], <https://arxiv.org./pdf/1506.01497.pdf>. However, in addition to solving the problem, further improvement of the detection accuracy is required. As one measure for improving the detection accuracy, it is necessary to increase the number of teacher data. However, the invention described in JP-A No. 2016-62524 cannot generate teacher data. Hence, there is a case where it may not be possible to reduce efforts and time taken to increase the number of teacher data per se.

The invention described in W. Liu, D. Anguelov, D. Erhan, C. Szegedy, and S. E. Reed, “SSD: Single Shot Multibox Detector”, Dec. 29, 2016, [online], <https://arxiv.org./pdf/1512.02325.pdf> also cannot generate teacher data. Therefore, it is impossible to reduce efforts and time taken to increase the number of teacher data per se. Furthermore, the invention described in W. Liu, D. Anguelov, D. Erhan, C. Szegedy, and S. E. Reed, “SSD: Single Shot Multibox Detector”, Dec. 29, 2016, [online], <https://arxiv.org./pdf/1512.02325.pdf> requires a plurality of individual object identification devices. Hence, there is a case where the image recognition device may have a complicated configuration or the data storage area may expand because each of the plurality of individual object identification devices uses storage space.

In one aspect, the present disclosure has an object to provide a teacher data generation apparatus, a teacher data generation method, a non-transitory computer-readable recording medium having stored therein a teacher data generation program, and an object detection system, the apparatus, the method, and the non-transitory computer-readable recording medium being capable of reducing efforts and time taken to generate teacher data.

In one aspect, the present disclosure can provide a teacher data generation apparatus, a teacher data generation method, a non-transitory computer-readable recording medium having stored therein a teacher data generation program, and an object detection system, the apparatus, the method, and the non-transitory computer-readable recording medium being capable of reducing efforts and time taken to generate teacher data.

The teacher data generation program is stored in a recording medium. For example, this enables the teacher data generation program to be installed in a computer. The recording medium having stored therein the teacher data generation program is a non-transitory recording medium. The non-transitory recording medium is not particularly limited and may be appropriately selected depending on the intended purpose. Examples of the non-transitory recording medium include a CD-ROM (Compact Disc-Read Only Memory) and a DVD-ROM (Digital Versatile Disc-Read Only Memory).

An embodiment of the present disclosure will be described below. However, the present disclosure should not be construed as being limited to this embodiment.

(Teacher Data Generation Apparatus)

A teacher data generation apparatus of the present disclosure is a teacher data generation apparatus configured to generate teacher data for performing object detection for detecting a specific identifying target, includes an identification model generation part and a teacher data generation part, preferably includes a reference data generation part and a selection part, and further includes other parts as needed.

<Reference Data Generation Part>

The reference data generation part is configured to convert moving image data including a specific identifying target into still image data and affix a label to the region of the specific identifying target cut out from each of a plurality of obtained still image data to generate reference data including the specific identifying target.

The “specific identifying target” refers to a specific target that is desired to be identified. The specific identifying target is not particularly limited and may be appropriately selected depending on the intended purpose. Examples of the specific identifying target include articles that can be sensed by the human vision, such as various images, figures, and characters.

Examples of the various images include human faces, animals (for example, bird, dog, cat, monkey, bear, and panda), fruits (for example, strawberry, apple, mandarin orange, and grape), steam locomotives, trains, automobiles (for examples, bus, truck, and family car), ships, and airplanes.

The “reference data including the specific identifying target” is reference data including 1 kind or a small number of kinds of specific identifying target(s). The “reference data including the specific identifying target” is preferably reference data including from 1 through 3 kinds of specific identifying targets, and more preferably reference data including 1 kind of a specific identifying target. When the reference data includes 1 kind of a specific identifying target, it is only necessary to identify whether an object is the identifying target or not, and it is unnecessary to identify which of a plurality of kinds of identifying targets the object is. Therefore, the event of erroneously recognizing any other kind can be reduced, and the number of reference data required can be reduced from hitherto required.

Specifically, when moving image data in which only 1 kind of a specific animal (for example, panda) appears is used, there is not a case where an object is erroneously recognized as any other animal than the 1 kind of the specific animal (for example, panda). Therefore, it is possible to generate a large number of teacher data for the 1 kind of the specific animal (for example, panda) based on a small number of reference data.

Hence, by generating an identification model based on a small number of reference data including 1 kind or a small number of kinds of specific identifying target(s) and detecting the specific identifying target(s) from moving image data using the generated identification model, it is possible to generate a large number of teacher data for the specific identifying target(s). This makes it possible to significantly reduce efforts and time taken to increase the number of teacher data.

The identification model is used for detecting the specific identifying target. Use of such an identification model makes it possible to reduce a false recognition of recognizing an object that is not the specific identifying target.

Specific identifying targets may be grouped down to genera, and 1 or a small number of reference data may be generated for each genus, to generate an identification model for each genus using the reference data. Then, teacher data may be generated for each genus and training may be performed using the teacher data generated for each genus. In this way, a general-purpose identification model can be generated.

Reference data may be generated separately for each dog breed such as Shiba, Akita, Maltese, Chihuahua, bulldog, toy poodle, and Doberman. Identification models may be generated for the respective dog breeds using 1 or a small number of reference data for the respective dog breeds. Teacher data may be generated for the plurality of dog breeds respectively, using the generated identification models. Next, teacher data generated for the plurality of dog breeds respectively may be collected and the label of the generated identification models may be changed to dog. In this way, teacher data for dog can be generated.

The “region” refers to a region enclosing the identifying target in, for example, a rectangular shape.

The “label” refers to a name (character string) affixed for indicating, identifying, or classifying the target.

<Identification Model Generation Part>

The identification model generation part is configured to learn a specific identifying target by an object recognition method using reference data including the specific identifying target, to generate an identification model of the specific identifying target.

The object recognition method is preferably an object recognition method by deep learning. Deep learning is one of machine learning methods using a multi-layer neural network (deep neural network) that mimics human brain neurons, and is a method that can automatically learn features of data.

The object recognition method by deep learning is not particularly limited and may be appropriately selected from known methods. Examples of the object recognition method by deep learning include the followings.

(1) R-CNN (Region-Based Convolutional Neural Network)

The algorithm of a R-CNN is based on a method of finding about 2,000 object candidates (Region Proposals) from an image by an existing method (Selective Search) for finding “objectness”.

Next, all of the images of the object candidate regions are resized to a certain size and processed through a Convolutional Neural Network (CNN) to extract features. Next, a plurality of SVMs (Support Vector Machines) are trained using the extracted features to estimate bounding boxes (exact locations in which the objects are enclosed) by category identification and regression. Finally, the positions of the candidate regions are corrected by regression of the coordinates of the rectangular shapes.

The R-CNN takes time for the detection process because it calculates the amounts of the features for the respective candidate regions extracted.

(2) SPP Net (Spatial Pyramid Pooling Net)

In a SPP net, Spatial Pyramid Pooling (SPP) is implemented to enable the feature maps of the final layer, which are obtained by convolution in a convolutional neural network, to be processed at a size of variable height or width.

The SPP net can operate at a higher speed than the R-CNN by generating large feature maps from 1 image and then vectorizing the features of the regions of object candidates (Region Proposals) by SPP

(3) Fast R-CNN (Fast Region-Based Convolutional Neural Network)

In a Fast R-CNN, simple variable-width pooling without the pyramid structure of SPP is implemented for region-of-interest layers (RoI pooling layers).

The Fast R-CNN can be trained at a time by multi-task loss that enables simultaneous training of classification and bounding box regression. The Fast R-CNN also manages to generate teacher data online.

With the multi-task loss introduced, error back propagation can be applied to all layers of the Fast R-CNN. Therefore, all layers can be trained.

The Fast R-CNN can realize object detection more accurately than the R-CNN and the SPP net.

(4) Faster R-CNN (Region-Based Convolutional Neural Network)

A Faster R-CNN can realize an end-to-end trainable architecture, with a network called region proposal network (RPN) configured to estimate object candidate regions and with class estimation for region-of-interest (RoI) pooling.

In order to output an object candidate, the region proposal network (RPN) is designed to simultaneously output both of a score indicating whether a region is an object or not and an object region.

Features are extracted from features of an entire image using a preset k number of anchor boxes, and the extracted features are input to the region proposal network (RPN) for estimation of whether each region is an object candidate or not.

The Faster R-CNN pools the ranges of output boxes (reg layers) estimated as object candidates as RoI (ROI pooling) as in the Fast R-CNN and inputs them to a classification network. In this way, the Faster R-CNN can realize final object detection.

With the deepened object candidate detection, the Faster R-CNN detects fewer, more accurate object candidates than the existing method (Selective Search), and can realize an execution speed of 5 fps on a GPU (using a VGG network). The Faster R-CNN also achieves a higher identification accuracy than the Fast R-CNN.

(5) YOLO (You Only Look Once)

YOLO is a method of previously segmenting an entire image into grids and determining an object class and a bounding box (exact location in which the object is enclosed) for each region.

The identification accuracy of YOLO is slightly poorer than that of the Faster R-CNN because the architectures of convolutional neural networks (CNN) have become simple. However, YOLO can achieve a good detection speed.

Unlike the methods using sliding windows and object candidates (Region Proposals), YOLO can learn the peripheral context simultaneously because it utilizes the full range of 1 image for learning. This makes it possible to suppress erroneous detection of the background. Erroneous detection of the background can be suppressed to about a half of the erroneous detection by the Fast R-CNN.

(6) SSD (Single Shot Multibox Detector)

SSD is an algorithm similar to the algorithm of YOLO, and designed to be able to output multi-scale detection boxes from output layers of various tiers.

The SSD is an algorithm that operates at a higher speed than the algorithm (YOLO) having the state-of-the-art detection speed, and realizes an accuracy comparable to the Faster R-CNN. The SSD can estimate the categories and locations of objects by applying a convolutional neural network (CNN) with a small filter size to feature maps. The SDD can achieve highly accurate detection by using feature maps of various scales and performing identification at various aspect ratios. The SSD is an end-to-end trainable algorithm that can achieve highly accurate detection even when the resolution is relatively low.

By using feature maps from different tiers, the SSD can detect an object having a relatively small size and hence can achieve accuracy even when the size of the input image is reduced. Therefore, the SSD can operate at a high speed.

<Teacher Data Generation Part>

The teacher data generation part is configured to detect a specific identifying target from moving image data including the specific identifying target based on deduction by an object recognition method using the generated identification model to generate teacher data for the specific identifying target.

The above-described object recognition methods by deep learning can be used for the deduction.

Teacher data is a set of “input data” and a “right answer label” that are used in supervised deep learning. By the “input data” being input to a neural network including many parameters, deep learning training is performed in a manner to update the difference (a weight during training) between a deduced label and the right answer label, to thereby obtain a trained weight. Hence, the form of teacher data depends on the problem to be learned (hereinafter, may also be referred to as “task”). Some examples of teacher data are presented in Table 1 below.

TABLE 1

| TASK | INPUT | OUTPUT |
|---|---|---|
| CLASSIFY WHAT ANIMAL | IMAGE | CLASS (ALSO |
| APPEARS IN IMAGE | | REFERRED TO |
| | | AS LABEL) |
| DETECT REGION OF CAR | IMAGE | COLLECTION OF |
| APPEARING IN | | IMAGES (1 CH |
| IMAGE IN PIXEL UNIT | | OF IMAGES ARE |
| | | OUTPUT PER OBJECT) |
| DETERMINE WHO | AUDIO | CLASS |
| UTTERS VOICE | | |

<Selection Part>

The selection part is configured to select arbitrary teacher data from the generated teacher data for the specific identifying target.

To make the teacher data useful for a deep learning process, the selection part is configured to perform, for example, format conversion, correction of a portion to be recognized, displacement correction, size correction, and exclusion of data unuseful as teacher data.

Embodiments of the present disclosure will be described below with reference to the drawings. However, the present disclosure should not be construed as being limited to the embodiments.

### Embodiment 1

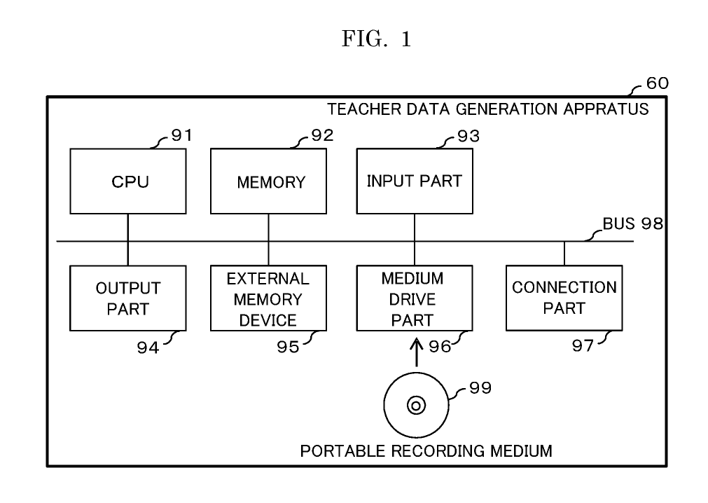

FIG. 1 is a diagram illustrating an example of a hardware configuration of a teacher data generation apparatus. In a teacher data generation apparatus 60 illustrated in FIG. 1, an external memory device 95 described below is configured to store a teacher data generation program, and a CPU (Central Processing Unit) 91 described below is configured to read out the program and execute the program to thereby operate as a reference data generation part 61, an identification model generation part 81, a teacher data generation part 82, and a selection part 83 described below.

The teacher data generation apparatus 60 illustrated in FIG. 1 includes the CPU 91, a memory 92, the external memory device 95, a connection part 97, and a medium drive part 96 that are connected to one another via a bus 98. An input part 93 and an output part 94 are connected to the teacher data generation apparatus 60.

The CPU 91 is a unit configured to execute various programs of the reference data generation part 61, the identification model generation part 81, the teacher data generation part 82, and the selection part 83 that are stored in, for example, the external memory device 95.

The memory 92 includes, for example, a RAM (Random Access Memory), a flash memory, and a ROM (Read Only Memory), and is configured to store programs and data of various processes constituting the teacher data generation apparatus 60.

Examples of the external memory device 95 include a magnetic disk device, an optical disk device, and an opto-magnetic disk device. The above-described programs and data of the various processes may be stored in the external memory device 95, and as needed, may be loaded onto the memory 92 and used.

Examples of the connection part 97 include a device configured to communicate with an external device through an arbitrary network (a line or a transmission medium) such as a LAN (Local Area Network) and a WAN (Wide Area Network) and perform data conversion accompanying the communication.

The medium drive part 96 is configured to drive a portable recording medium 99 and access the content recorded in the portable recording medium 99.

Examples of the portable recording medium 99 include arbitrary computer-readable recording media such as a memory card, a floppy (registered trademark) disk, a CD-ROM (Compact Disk-Read Only Memory), an optical disk, and an opto-magnetic disk. The above-described programs and data of the various processes may be stored in the portable recording medium 99, and as needed, may be loaded onto the memory 92 and used.

Examples of the input part 93 include a keyboard, a mouse, a pointing device, and a touch panel. The input part 93 is used for an operator to input his/her instructions, or is used for inputting a content to be recorded onto the portable recording medium 99 when the portable recording medium 99 is driven.

Examples of the output part 94 include a display and a printer. The output part 94 is used for displaying, for example, a process result to an operator of the teacher data generation apparatus 60.

For acceleration of the computing processes of the CPU 91, the teacher data generation apparatus 60 may be configured to take advantage of an accelerator such as a GPU (Graphics Processing Unit) and a FPGA (Field-Programmable Gate Array), although not illustrated in FIG. 1.

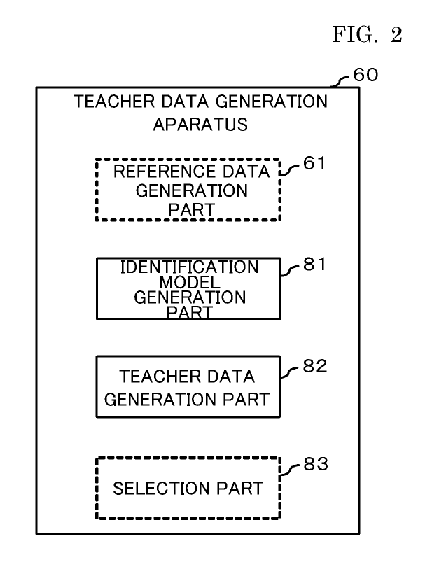

FIG. 2 is a block diagram illustrating an example of the entire teacher data generation apparatus of the embodiment 1. The teacher data generation apparatus 60 illustrated in FIG. 2 includes the identification model generation part 81 and the teacher data generation part 82, and preferably includes the reference data generation part 61 and the selection part 83. Here, the configuration of the identification model generation part 81 and the teacher data generation part 82 corresponds to the “teacher data generation apparatus” of the present disclosure. The processes for executing the identification model generation part 81 and the teacher data generation part 82 correspond to the “teacher data generation method” of the present disclosure. The program causing a computer to execute the processes of the identification model generation part 81 and the teacher data generation part 82 corresponds to the “teacher data generation program” of the present disclosure.

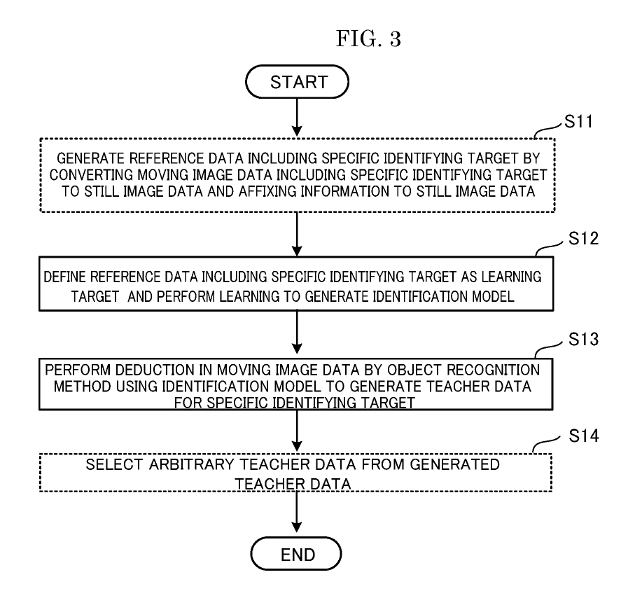

FIG. 3 is a flowchart illustrating an example of a flow of processes of the entire teacher data generation apparatus. The flow of processes of the entire teacher data generation apparatus will be described below with reference to FIG. 2.

In the step S11, the reference data generation part 61 converts moving image data including 1 kind or a small number of kinds of specific identifying target(s) into still image data. The reference data generation part 61 cuts out the region(s) of the 1 kind or the small number of kinds of specific identifying target(s) from the obtained still image data and affixes labels to the regions to thereby generate reference data including the 1 kind or the small number of kinds of specific identifying target(s). Then, the flow moves to the step S12. The process for generating the reference data may be performed by an operator or by software. The step S11 is an optional process and may be skipped.

In the step S12, the identification model generation part 81 defines the reference data including the 1 kind or the small number of kinds of specific identifying target(s) as the learning target, and performs learning by an object recognition method to thereby generate an identification model of the 1 kind or the small number of kinds of specific identifying target(s). Then, the flow moves to the step S13.

In the step S13, the teacher data generation part 82 detects the 1 kind or the small number of kinds of specific identifying target(s) from moving image data including the 1 kind or the small number of kinds of specific identifying target(s) based on deduction by the object recognition method using the generated identification model to thereby generate teacher data for the 1 kind or the small number of kinds of specific identifying target(s). Then, the flow moves to the step S14.

In the step S14, the selection part 83 selects arbitrary teacher data from the generated teacher data for the 1 kind or the small number of kinds of specific identifying target(s). Then, the flow ends. The process for selecting the teacher data may be performed by an operator or by software. The step S14 is an optional process and may be skipped.

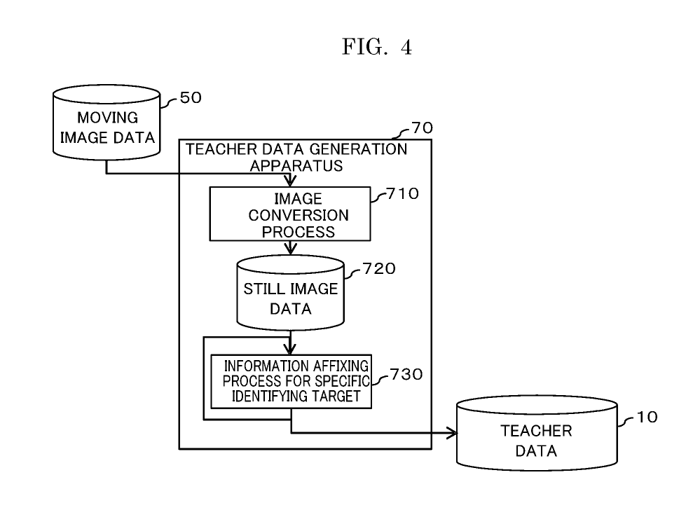

As illustrated in FIG. 4, with an existing teacher data generation apparatus 70, moving image data 50 in which a specific identifying target appears has been converted into still image data 720 manually in an image conversion process 710. Then, in order to generate teacher data 10, the region of the identifying target appearing in the still image has been cut out from the obtained still image data 720 manually and label information has been affixed to the cut-out still image manually in an information affixing process 730 for the specific identifying target.

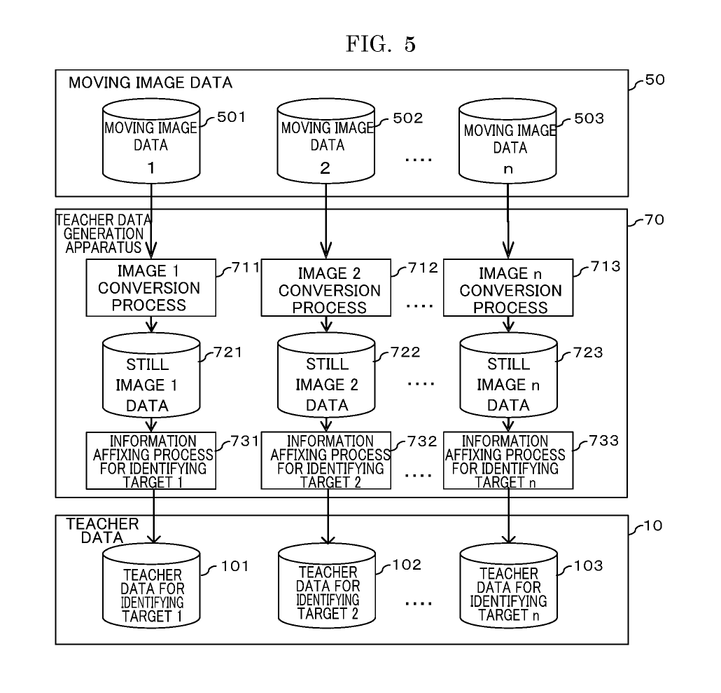

Hitherto, moving image data 1 501, moving image data 2 502, . . . , and moving image data n 503 illustrated in FIG. 5 have been converted into still image 1 data 721, still image 2 data 722, . . . , and still image n data 723 manually in an image 1 conversion process 711, an image 2 conversion process 712, . . . , and an image n conversion process 713 of the teacher data generation apparatus 70. This image conversion can be easily automated with a program using an existing library. However, it has been necessary to manually perform the information affixing process that is performed in an information affixing process 731 for an identifying target 1, an information affixing process 732 for an identifying target 2, . . . , and an information affixing process 733 for an identifying target n for cutting out the regions of the identifying targets from the still images and affixing labels to the cut-out still images. As a result, a lot of efforts and time have been taken to generate teacher data including 1,000 or more images per 1 kind of an identifying target.

A conceivable method is to replace this information affixing process with object recognition using a model learned from 1 or a small number of teacher data each including about 10 through 100 images per 1 kind of an identifying target. However, if object recognition for a plurality of identifying targets is performed with 1 or a small number of teacher data, there is a high probability that an object other than the identifying targets may be erroneously recognized, and a percentage at which wrong teacher data will be mixed in teacher data to be generated may be high.

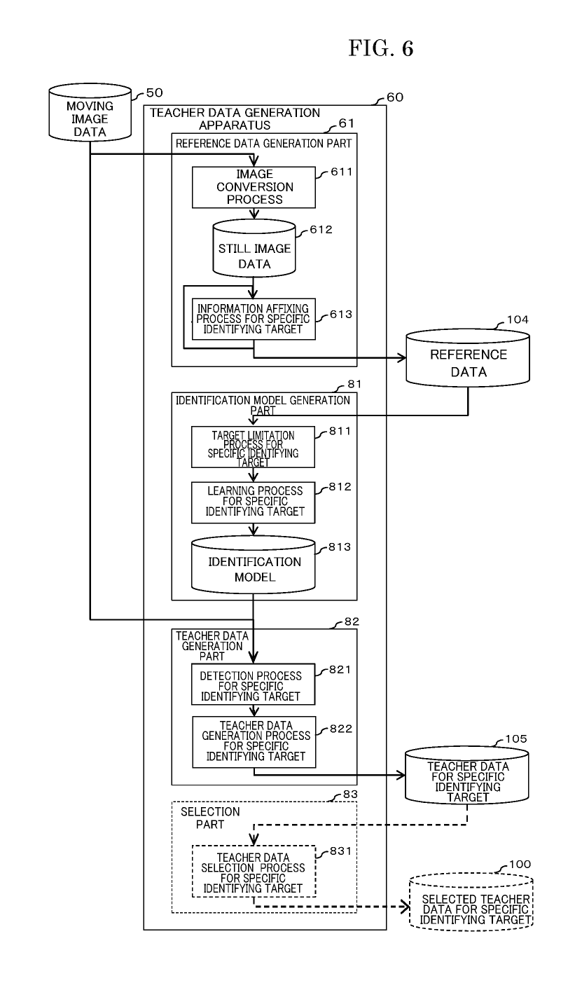

FIG. 6 is a block diagram illustrating an example of the process of each part in the entire teacher data generation apparatus of the present disclosure. An embodiment in which Faster R-CNN is used as an object recognition method for recognizing an identifying target to generate teacher data as a set of an image data jpg file and a PASCAL VOC-format XML file will be described below. The object recognition method and the block diagram of the teacher data generation apparatus are presented as non-limiting examples.

[Moving Image Data]

The moving image data 50 is moving image data in which 1 kind or a small number of kinds of specific identifying target(s) appear(s). Examples of the moving image format include avi and wmv formats.

It is preferable that the 1 kind or the small number of kinds of specific identifying target(s) include 1 kind of a specific identifying target. Examples of the specific identifying target when it is an animal include dog, cat, bird, monkey, bear, and panda. When there is 1 kind of a specific identifying target, it is only necessary to determine whether the identifying target is present or absent. Therefore, there is no case of erroneous recognition, and the number of reference data required may be 1 or a smaller number than hitherto required.

[Reference Data Generation Part]

The reference data generation part 61 performs an image conversion process 611 and an information affixing process 613 for a specific identifying target to thereby generate reference data 104 including 1 kind or a small number of kinds of specific identifying target(s). Generation of reference data is optional. Data provided by an operator may be used as is, or may be appropriately processed before use.

In the image conversion process 611, with a program using an existing library, frames are thinned out from the moving image data 50 by extraction at regular intervals or random extraction, to convert the moving image data 50 into 1 or a small number of still image data 612.

The still image data 612 is/are 1 or a small number of still image data each including about 10 through 100 images in which 1 or a small number of kinds of specific identifying target(s) appear(s). Examples of the still image format include jpg.

In the information affixing process 613 for a specific identifying target, information on the region and the label of a specific identifying target appearing in the still image data 612 is generated as a PASCAL VOC-format XML file with an existing tool or manually by an operator. The information affixing process 613 for a specific identifying target is the same as the existing information affixing target 730 for a specific identifying target illustrated in FIG. 4. However, because frames have been thinned out to 1 or a small number of frame(s), the information affixing process 613 for a specific identifying target illustrated in FIG. 6 can save efforts and time significantly, compared with the existing information affixing process 730 for a specific identifying target illustrated in FIG. 4.

In the way described above, 1 or a small number of reference data 104 each including about 10 through 100 sets of jpg files containing the still image data 612 and PASCAL VOC-format XML files is/are generated. The form of the reference data 104 is not particularly limited to the form as a set of a still image data jpg file and a PASCAL VOC-format XML file so long as it is a form that can be input to the identification model generation part 81.

[Identification Model Generation Part]

The identification model generation part 81 performs a target limitation process 811 for a specific identifying target and a learning process 812 for a specific identifying target to thereby generate an identification model 813.

In the target limitation process 811 for a specific identifying target, a search is performed through the labels in the XML files in the 1 or the small number of reference data 104, to extract the label of a specific identifying target and define the specific identifying target as the learning target of the learning process 812 for a specific identifying target. Namely, in the target limitation process 811 for a specific identifying target, 1 kind or the small number of kinds of specific identifying target(s) in the 1 or the small number of reference data 104 is/are dynamically defined, so that the specific identifying target(s) may be referable by an object recognition method by deep learning.

In the learning process 812 for a specific identifying target, the 1 kind or the small number of kinds of specific identifying target(s), which is/are defined in the target limitation process 811 for a specific identifying target using the 1 or the small number of reference data 104 as input, is/are learned, to generate an identification model 813. Learning is performed by an object recognition method by deep learning. As the object recognition method by deep learning, Faster R-CNN is used.

Models learned by existing object recognition methods by deep learning have been used for detecting a plurality of kinds of identifying targets. As compared with this, the identification model 813 is used for detecting the 1 kind or the small number of kinds of specific identifying target(s). Use of the identification model 813 of the 1 kind or the small number of kinds of specific identifying target(s) makes it possible to reduce erroneous recognition of any objects other than the 1 kind or the small number of kinds of specific identifying target(s).

[Teacher Data Generation Part]

The teacher data generation part 82 performs a detection process 821 for a specific identifying target and a teacher data generation process 822 for a specific identifying target to thereby generate teacher data 105 for a specific identifying target.

In the detection process 821 for a specific identifying target, the moving image data 50 used by the reference data generation part 61 and the identification model 813 are input, and deduction is performed in each frame of the moving image data 50 by an object recognition method by deep learning. The deduction is performed in order to detect the 1 kind or the small number of kinds of specific identifying target(s) defined in the target limitation process 811 for a specific identifying target.

As the object recognition method by deep learning, Faster R-CNN is used.

In the teacher data generation process 822 for a specific identifying target, teacher data 105 for a specific identifying target is generated automatically. Teacher data 105 for a specific identifying target is a set of a jpg file containing still image data in which the 1 kind or the small number of kinds of specific identifying target(s) appear(s) and a PASCAL VOC-format XML file containing the information on the region and the label of the specific identifying target.

The form of the teacher data 105 for a specific identifying target is the same as the form of the reference data 104, but is not limited to the form as a set of a still image data jpg file and a PASCAL VOC-format XML file.

[Selection Part]

It is preferable that the teacher data generation apparatus 60 include the selection part 83 in order to select arbitrary teacher data from the teacher data 105 for a specific identifying target. Selection of teacher data is optional, and may be skipped when the number of teacher data 105 for a specific identifying target falls short or when selection of teacher data 105 for a specific identifying target is unnecessary.

The selection part 83 performs teacher data selection process 831 for a specific identifying target to thereby generate selected teacher data 100 selected for a specific identifying target.

In the teacher data selection process 831 for a specific identifying target, for example, format conversion, correction of a portion to be recognized, displacement correction, size correction, and exclusion of data unuseful as teacher data are performed in order to generate useful teacher data.

In the teacher data selection process 831 for a specific identifying target, still image data representing a specific identifying target that is cut out using the region contained in the teacher data 105 for the specific identifying target is displayed, or still image data representing a specific identifying target with its region enclosed within a box is displayed.

With a selection unit configured to select desired teacher data or select unnecessary teacher data from the displayed still image data, selection of the teacher data is performed manually or by software, to thereby generate selected teacher data 100 for a specific identifying target based on the selected teacher data.

In the way described above, the teacher data generation apparatus 60 can generate a large number of teacher data automatically based on the 1 or the small number of reference data 104. Therefore, efforts and time taken to generate teacher data can be reduced.

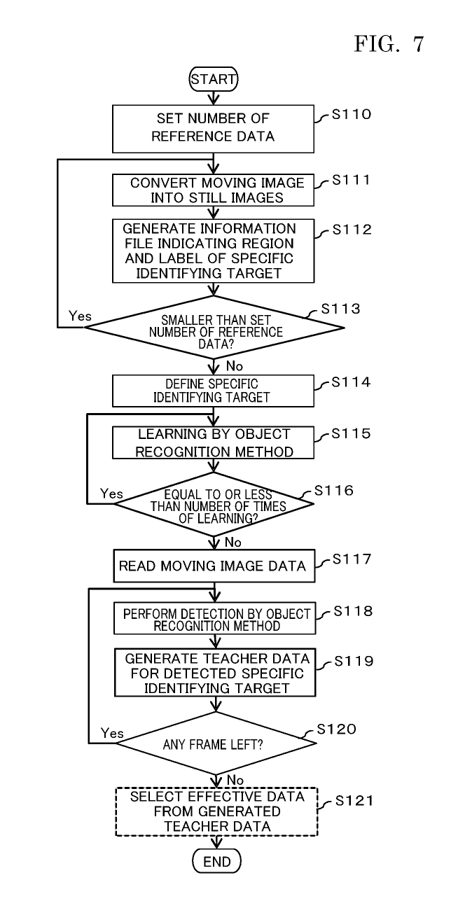

FIG. 7 is a flowchart illustrating an example of a flow of processes of the respective parts in the entire teacher data generation apparatus. The flow of the processes of the respective parts of the entire teacher data generation apparatus will be described below with reference to FIG. 6.

In the step S110, the reference data generation part 61 sets the number of reference data to be generated in the image conversion process 611. Then, the flow moves to the step S111. The set number of reference data to be generated may be 1 or a small number each including about 10 through 100 images.

In the step S111, the reference data generation part 61 converts moving image data 50 from 0 frame thereof into still images at intervals determined by the set number of reference data using an existing library, to thereby generate, for example, jpg files. Then, the flow moves to the step S112. Note that among the frames of the moving image data 50 in which frames a specific identifying target appears, such a number of frames desired to be used as teacher data as corresponding to the set number may be converted from moving image data to still images using an existing library, to thereby generate, for example, jpg files.

In the step S112, in the information affixing process 613 for a specific identifying target, the reference data generation part 61 generates reference data. Then, the flow moves to the step S113.

The reference data is generated to include a PASCAL VOC-format XML file containing information on the region and the label of a specific identifying target appearing in the jpg files generated manually or using an existing tool.

In the step S113, the reference data generation part 61 determines whether or not the number of generated reference data is smaller than the set number of reference data.

When the reference data generation part 61 determines that the number of generated reference data is smaller than the set number of reference data, the flow returns to the step S111. On the other hand, when the reference data generation part 61 determines that the number of generated reference data is larger than the set number of reference data, the flow moves to the step S114. Through repetition of the reference data generation process up to the set number of reference data in this way, reference data 104 is generated. Because focus is narrowed down on 1 kind or a small number of kinds of specific identifying target(s), 1 or a small number of reference data is/are obtained.

The step S110 to the step S121 are optional. Therefore, reference data provided by an operator may be used.

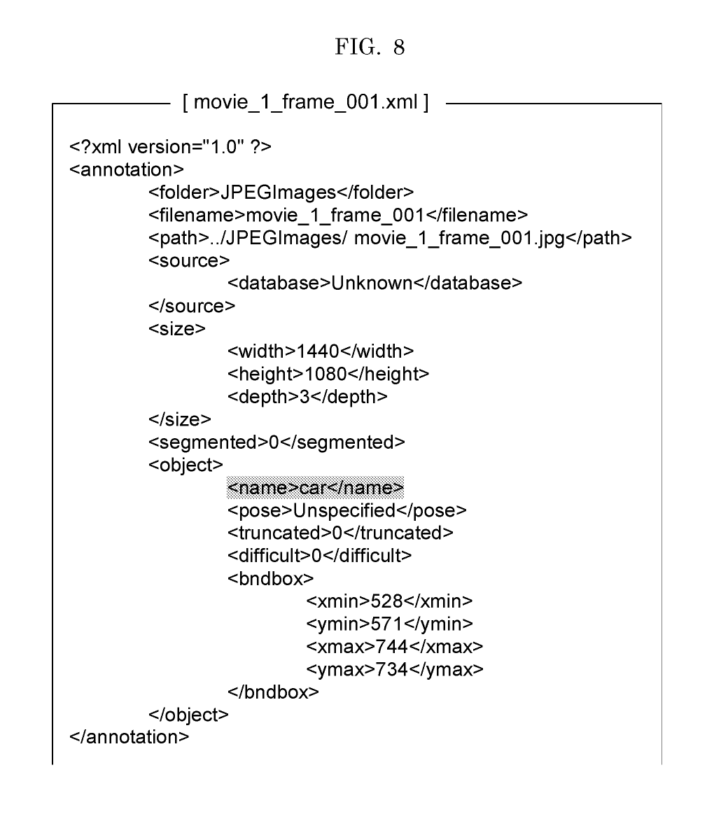

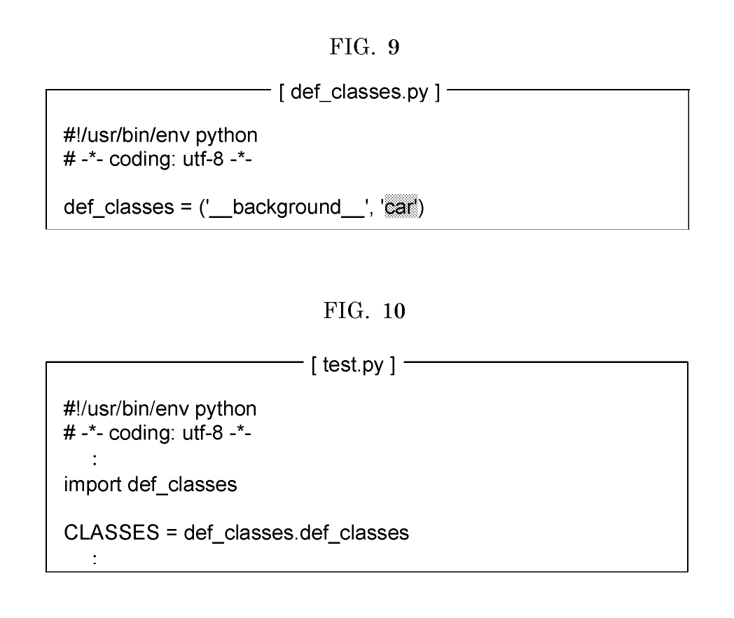

In the step S114, in the target limitation process 811 for a specific identifying target, the identification model generation part 81 searches for a label (<name>car</name> in FIG. 8) in the XML files in the reference data 104 as illustrated in FIG. 8. The identification model generation part 81 defines the specific identifying target (1 kind of an identifying target: car in FIG. 8) as a python import file as illustrated in FIG. 9. When the specific identifying target is defined to be referable by Faster R-CNN as illustrated in FIG. 10, the flow moves to the step S115.

In the step S114, dynamic switching among identifying targets for which an identification model is to be generated is available by changing the reference data to be used to reference data including a different label.

In the step S115, in the learning process 812 for a specific identifying target, with reference to the import file defined in the target limitation process 811 for a specific identifying target, learning is performed with Faster R-CNN using the 1 or the small number of reference data 104, to thereby generate an identification model 813. Then, the flow moves to the step S116.

In the step S116, the identification model generation part 81 determines whether or not the number of times of learning is equal to or less than a specified number of times of learning. When the identification model generation part 81 determines that the number of times of learning is equal to or less than the specified number of times of learning, the flow returns to the step S115. On the other hand, when the identification model generation part 81 determines that the number of times of learning is greater than the specified number of times of learning, the flow moves to the step S117.

As the number of times of learning, for example, a fixed number of times or a number of times specified by an argument may be used.

The number of times of learning may be used as train accuracy. When the number of times of learning is less than a specified train accuracy, the flow returns to the step S115. On the other hand, when the number of times of learning is equal to or greater than the train accuracy, the flow moves to the step S117.

As the train accuracy, for example, a fixed train accuracy and a train accuracy specified by an argument may be used.

In the step S117, in the detection process 821 for a specific identifying target, the teacher data generation part 82 reads the moving image data 50 used by the reference data generation part 61. Then, the flow moves to the step S118.

In the step S118, the teacher data generation part 82 processes the read moving image data 50 from the frame 0 sequentially 1 frame at a time, to perform detection with Faster R-CNN with reference to the import file defined in the target limitation process 811 for a specific identifying target performed by the identification model generation part 81. Then, the flow moves to the step S119.

In the step S119, in the teacher data generation process 822 for a specific identifying target, the teacher data generation part 82 generates teacher data for a specific identifying target. Then, the flow moves to the step S120.

Teacher data for a specific identifying target includes a jpg file detected in the detection process 821 for a specific identifying target and a PASCAL VOC-format XML file containing information on the region and the label of the specific identifying target appearing in the jpg file.

In the step S120, the teacher data generation part 82 determines whether or not there is any frame left in the read moving image data 50. When the teacher data generation part 82 determines that there is any frame left, the flow returns to the step S118. On the other hand, when the teacher data generation part 82 determines that there is no frame left, the flow moves to the step S121.

A jpg file of the region of a specific identifying target cut out from the detected jpg file may be generated as teacher data. By repetition of detection through all frames of the moving image data 50, the teacher data generation part 82 generates teacher data 105 for a specific identifying target.

In the step S121, in the teacher data selection process 831 for a specific identifying target, still image data that represent a specific identifying target cut out using the regions contained in the teacher data 105 for the specific identifying target, or still image data that represent a specific identifying target with its region enclosed within a box are all displayed.

Next, with a selection unit configured to select effective teacher data or select unnecessary teacher data, selection of the teacher data is performed manually or by software, to thereby generate selected teacher data 100 for a specific identifying target based on the selected teacher data. Then, the flow ends. The step S121 is optional.

According to the embodiment 1, a large number of teacher data necessary for training by deep learning can be generated automatically from 1 or a small number of reference data. Therefore, efforts and time taken for generation of teacher data can be reduced.

### Embodiment 2

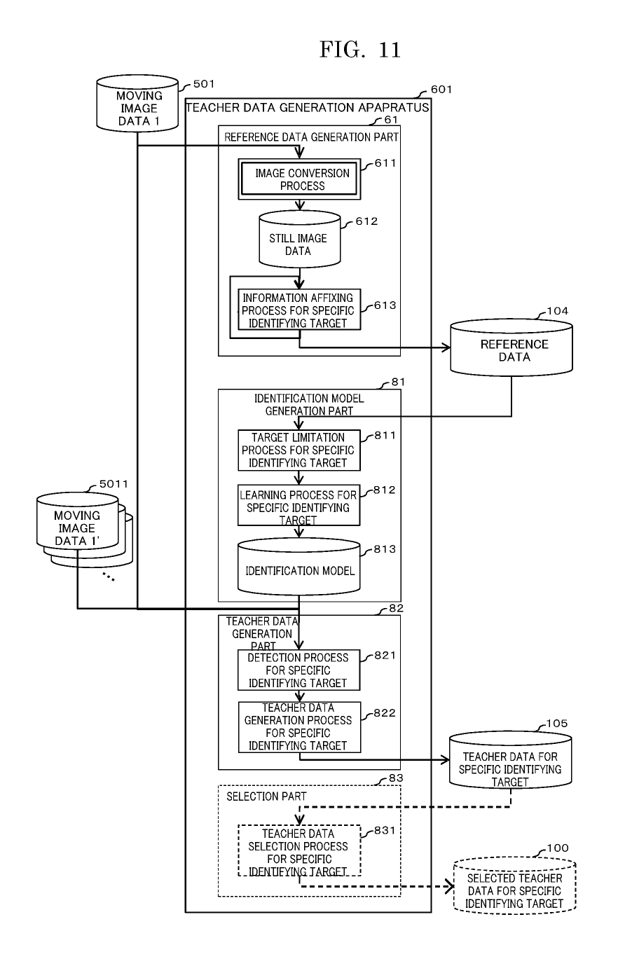

FIG. 11 is a block diagram illustrating an example of a process of each part in an entire teacher data generation apparatus of the embodiment 2. A teacher data generation apparatus 601 of the embodiment 2 illustrated in FIG. 11 is the same as the embodiment 1, except that a function for processing a plurality of moving image data is added in the detection process 821 for a specific identifying target performed by the teacher data generation part 82. Hence, any components that are the same as the components in the embodiment 1 already described will be denoted by the same reference numerals and description about such components will be skipped.

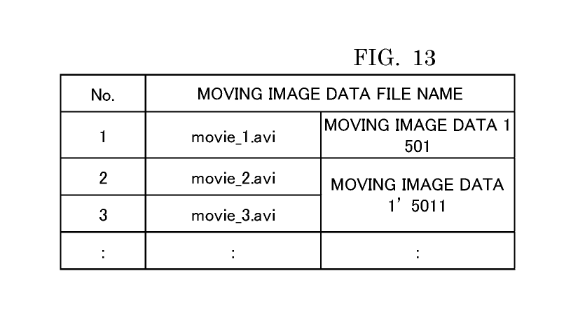

A moving image data table illustrated in FIG. 13 is an example of the plurality of moving image data. Moving image data 1′ 5011 is another moving image data in which 1 kind or small number of kinds of specific identifying target(s) appear(s) as in the moving image data 1 501. The format of the moving image is not particularly limited and may be appropriately selected depending on the intended purpose. Examples of the moving image format include avi and wmv formats. A plurality of moving image data may be designated as moving image data 1′ 5011.

In the detection process 821 for a specific identifying target, the moving image data 1 501 used by the reference data generation part 61 and the identification model 813 are received as input, and detection of a specific identifying target defined in the target limitation process 811 for a specific identifying target is performed in each frame of the moving image data 1 501.

Subsequently, the moving image data 1′ 5011 and the identification model 813 are received as input, and detection of a specific identifying target defined in the target limitation process 811 for a specific identifying target is performed in each frame of the moving image data 1′ 5011. When a plurality of moving image data are designated as 1′ 5011, the flow is repeated from the detection process 821 for a specific identifying target for new moving image data.

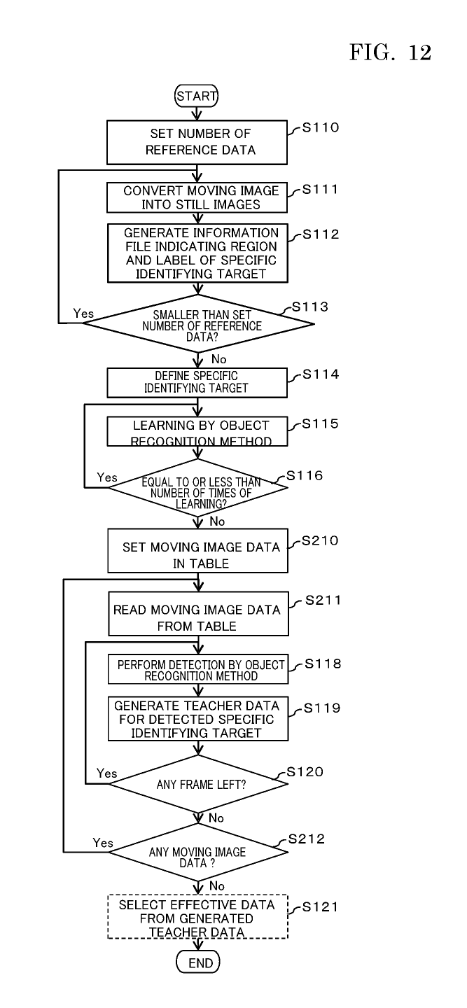

FIG. 12 is a flowchart illustrating an example of the flow of processes of the respective parts in the entire teacher data generation apparatus 601 of the embodiment 2. The flow of processes of the respective parts in the entire teacher data generation apparatus will be described below with reference to FIG. 11.

The step S110 to the step S116 in FIG. 12 are the same as in the flowchart of the embodiment 1 illustrated in FIG. 7. Therefore, description about these steps will be skipped.

In the step S210, in the detection process 821 for a specific identifying target, the file names of the image data of firstly the moving image data 1 501 and then the moving image data 1′ 5011, which are used in the image conversion process 611, are sequentially set in the moving image data table illustrated in FIG. 13. Then, the flow moves to the step S211. The file names of the image data may be read from the files or read through an input device.

In the step S211, image data are read from the moving image data table illustrated in FIG. 13 from the top image data sequentially. Then, the flow moves to the step S118.

In the step S118, the moving image data 1 501 read from the moving image data table illustrated in FIG. 13 is processed from the frame 0 sequentially, to perform detection with Faster R-CNN with reference to the import file defined in the target limitation process 811 for a specific identifying target. Then, the flow moves to the step S119.

In the step S119, in the teacher data generation process 822 for a specific identifying target, the teacher data generation part 82 generates teacher data for a specific identifying target. Then, the flow moves to the step S120.

The teacher data for a specific identifying target is generated to include a jpg file detected in the detection process 821 for a specific identifying target and a PASCAL VOC-format XML file containing the information on the region and the label of the specific identifying target appearing in the jpg file.

In the step S120, the teacher data generation part 82 determines whether or not there is any frame left in the read moving image data 1 501. When the teacher data generation part 82 determines that there is any frame left in the read moving image data 1 501, the flow returns to the step S118. On the other hand, when the teacher data generation part 82 determines that there is no frame left in the read moving image data 1 501, the flow returns to the step S212.

In the step S212, the teacher data generation part 82 determines whether or not there is any unprocessed moving image data with reference to the moving image data table illustrated in FIG. 13. When the teacher data generation part 82 determines that there is any unprocessed moving image data, the flow returns to the step S211, for the process to be performed based on new moving image data. On the other hand, when the teacher data generation part 82 determines that there is no unprocessed moving image data, the flow moves to the step S121.

In the step S121, in the teacher data selection process 831 for a specific identifying target, still image data that represent a specific identifying target cut out using the regions contained in the teacher data 105 for the specific identifying target, or still image data that represent a specific identifying target with its region enclosed within a box are all displayed.

Next, with a selection unit configured to select effective teacher data or select unnecessary teacher data, selection of the teacher data is performed manually or by software, to thereby generate selected teacher data 100 for a specific identifying target based on the selected teacher data. Then, the flow ends. The step S121 is optional.

According to the embodiment 2, a large number of teacher data can be generated automatically. Therefore, efforts and time taken for generation of teacher data can be reduced even more compared with the embodiment 1.

### Embodiment 3

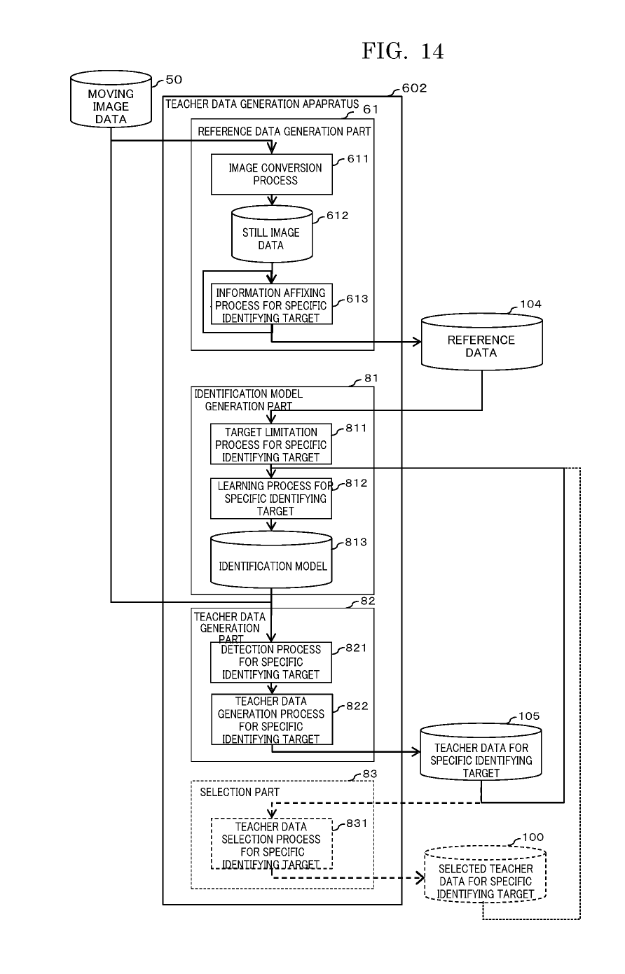

FIG. 14 is a block diagram illustrating an example of a process of each part in an entire teacher data generation apparatus of the embodiment 3. A teacher data generation apparatus 602 of the embodiment 3 illustrated in FIG. 14 is the same as the embodiment 1, except that a function for performing an iterative process using the teacher data 105 for a specific identifying target or the selected teacher data 100 for a specific identifying target in the learning process 812 for a specific identifying target is added. Hence, any components that are the same as the components in the embodiment 1 already described will be denoted by the same reference numerals and description about such components will be skipped.

An iteration number indicating how many times an iterative process is performed using the teacher data 105 for a specific identifying target or the selected teacher data 100 for a specific identifying target in the learning process 812 for a specific identifying target is set.

Learning of a specific identifying target defined in the target limitation process 811 for a specific identifying target using the reference data 104 as input is performed, to thereby generate an identification model 813, or update the identification model 813 in an iterative process.

In the teacher data generation process 822 for a specific identifying target performed by the teacher data generation part 82, the flow is repeated from the learning process 812 for a specific identifying target using the teacher data 105 for a specific identifying target as input a number of times corresponding to the iteration number set in the learning process 812 for a specific identifying target.

In the teacher data selection process 831 for a specific identifying target, still image data representing a specific identifying target that is cut out using the region contained in the teacher data 105 for the specific identifying target is displayed, or still image data representing a specific identifying target with its region enclosed within a box is displayed.

With a selection unit configured to select desired teacher data or select unnecessary teacher data from the displayed still image data, selection of the teacher data is performed manually or by software, to thereby generate selected teacher data 100 for a specific identifying target based on the selected teacher data.

The flow is repeated from the learning process 812 for a specific identifying target using the selected teacher data 100 for a specific identifying target as input a number of times corresponding to the iteration number set in the learning process 812 for a specific identifying target.

Because there is a possibility of over-learning if learning is performed a plurality of times using the same teacher data, it is preferable not to use the teacher data redundantly in the feedback process.

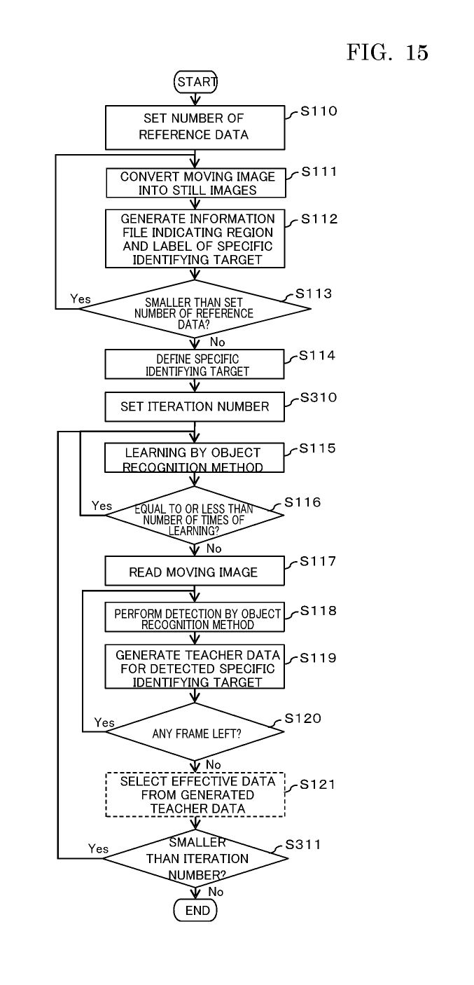

FIG. 15 is a flowchart illustrating an example of the flow of processes of the respective parts in the entire teacher data generation apparatus. The flow of processes of the respective parts in the entire teacher data generation apparatus will be described below with reference to FIG. 14.

The step S110 to the step S114 in FIG. 15 are the same as in the flowchart of the embodiment 1 illustrated in FIG. 7. Therefore, description about these steps will be skipped.

In the step S310, in the learning process 812 for a specific identifying target, the iteration number indicating how many times an iterative process is to be performed using the teacher data 105 for a specific identifying target or the selected teacher data 100 for a specific identifying target in the learning process 812 for a specific identifying target is set. Then, the flow moves to the step S115. The iteration number may be read from a file or through an input device, or may be a fixed value.

In the step S115, with reference to the import file defined in the target limitation process 811 for a specific identifying target, learning is performed with Faster R-CNN using the reference data 104, to thereby generate an identification model 813. Then, the flow moves to the step S116.

In the step S116, the identification model generation part 81 determines whether or not the number of times of learning is equal to or less than a specified number of times of learning. When the identification model generation part 81 determines that the number of times of learning is equal to or less than the specified number of times of learning, the flow returns to the step S115. On the other hand, when the identification model generation part 81 determines that the number of times of learning is greater than the specified number of times of learning, the flow moves to the step S117.

As the number of times of learning, for example, a fixed number of times, a number of times specified by an argument, or train accuracy may be used.

In the step S117, in the detection process 821 for a specific identifying target, the teacher data generation part 82 reads the moving image data 50 used by the reference data generation part 61. Then, the flow moves to the step S118.

In the step S118, the teacher data generation part 82 processes the read moving image data 50 from the frame 0 sequentially 1 frame at a time, to perform detection with Faster R-CNN with reference to the import file defined in the target limitation process 811 for a specific identifying target. Then, the flow moves to the step S119.

In the step S119, in the teacher data generation process 822 for a specific identifying target, the teacher data generation part 82 generates teacher data including a jpg file detected in the detection process 821 for a specific identifying target and a PASCAL VOC-format XML file containing the information on the region and the label of the specific identifying target appearing in the jpg file. Then, the flow moves to the step S120.

A jpg file of the region of a specific identifying target cut out from the detected jpg file may be generated as teacher data. By repetition of detection through all frames of the moving image data 50, the teacher data generation part 82 generates teacher data 105 for a specific identifying target.

In the step S120, the teacher data generation part 82 determines whether or not there is any frame left in the read moving image data 50. When the teacher data generation part 82 determines that there is any frame left in the read moving image data 50, the flow returns to the step S118. On the other hand, when the teacher data generation part 82 determines that there is no frame left, the flow moves to the step S121.

In the step S121, in the teacher data selection process 831 for a specific identifying target, still image data that represent a specific identifying target cut out using the regions contained in the teacher data 105 for the specific identifying target, or still image data that represent a specific identifying target with its region enclosed within a box are all displayed.

Next, with a selection unit configured to select effective teacher data or select unnecessary teacher data, selection of the teacher data is performed manually or by software, to thereby generate selected teacher data 100 for a specific identifying target based on the selected teacher data. Then, the flow moves to the step S311. The step S121 is optional.

In the step S311, the teacher data generation part 82 or the selection part 83 determines whether or not the number of times of iteration is smaller than the set iteration number. When the teacher data generation part 82 or the selection part 83 determines that the number of times of iteration is smaller than the iteration number, the flow returns to the step S115. On the other hand, when the teacher data generation part 82 or the selection part 83 determines that the number of times of iteration is greater than the iteration number, the flow ends.

According to the embodiment 3, a large number of teacher data can be generated automatically. Therefore, efforts and time taken for generation of teacher data can be reduced even more compared with the embodiment 1.

### Embodiment 4

A teacher data generation apparatus of the embodiment 4 is produced in the same manner as in the embodiment 1, except that the teacher data generation apparatus of the embodiment 4 includes the components for the process added in the embodiment 2 and the components for the process added in the embodiment 3 in combination in addition to the components of the teacher data generation apparatus of the embodiment 1.

According to the embodiment 4, the number of teacher data generated automatically increases even more and efforts and time taken for generation of teacher data can be reduced even more compared with the embodiment 1.

### Embodiment 5

(Object Detection System)

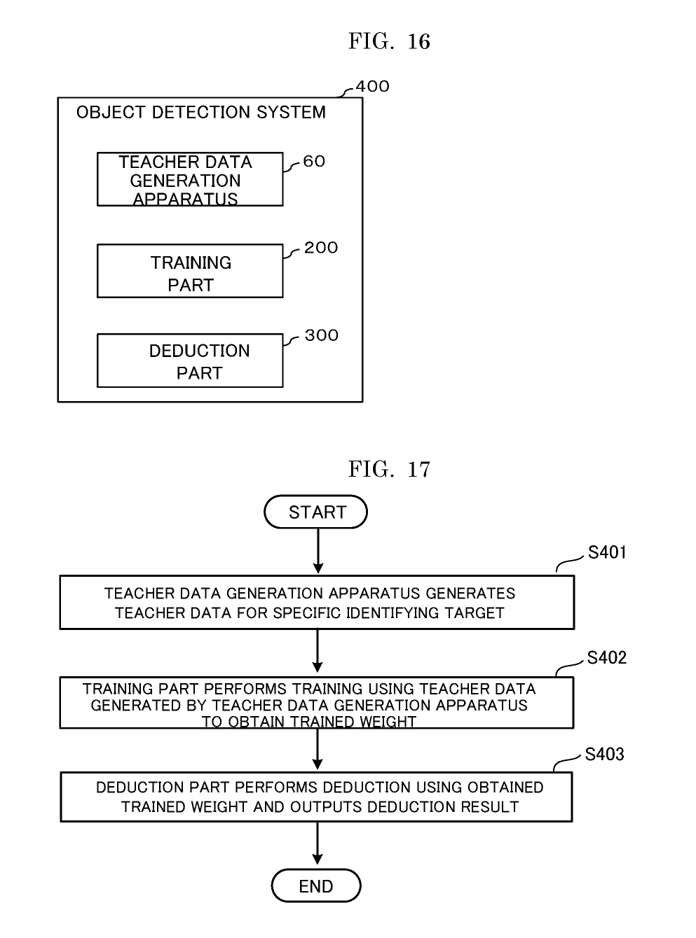

FIG. 16 is a block diagram illustrating an example of an entire object detection system of the present disclosure. An object detection system 400 illustrated in FIG. 16 includes a teacher data generation apparatus 60, a training part 200, and a deduction part 300.

FIG. 17 is a flowchart illustrating an example of a flow of processes of the entire object detection system. The flow of processes of the entire object detection system will be described below with reference to FIG. 16.

In the step S401, the teacher data generation apparatus 60 generates teacher data for 1 kind or a small number of kinds of specific identifying target(s). Then, the flow moves to the step S402.

In the step S402, the training part 200 performs training using the teacher data generated by the teacher data generation apparatus 60, to thereby obtain a trained weight. Then, the flow moves to the step S403.

In the step S403, the deduction part 300 performs deduction using the obtained trained weight, to thereby obtain a deduction result. Then, the flow ends.

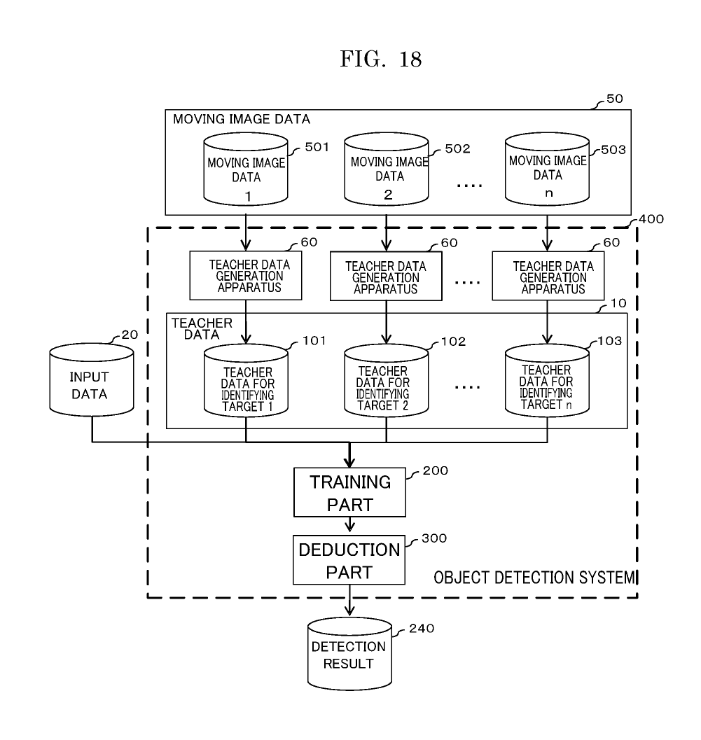

FIG. 18 is a block diagram illustrating another example of an entire object detection system of the present disclosure. In the object detection system 400 illustrated in FIG. 18, the teacher data generation apparatus 60 generates teacher data 101 for an identifying target 1, teacher data 102 for an identifying target 2, . . . , and teacher data 103 for an identifying target n based on the moving image data 1 501, the moving image data 2 502, . . . , and the moving image data n 503. The generated teacher data is used for training by the training part 200. A detection result 240 is obtained by the deduction part 300.

As the teacher data generation apparatus 60, the teacher data generation apparatus 60 of the present disclosure can be used.

The training part 200 and the deduction part 300 are not particularly limited, and an ordinary training part and an ordinary deduction part can be used.

<Training Part>

The training part 200 performs training using teacher data generated by the teacher data generation apparatus 60.

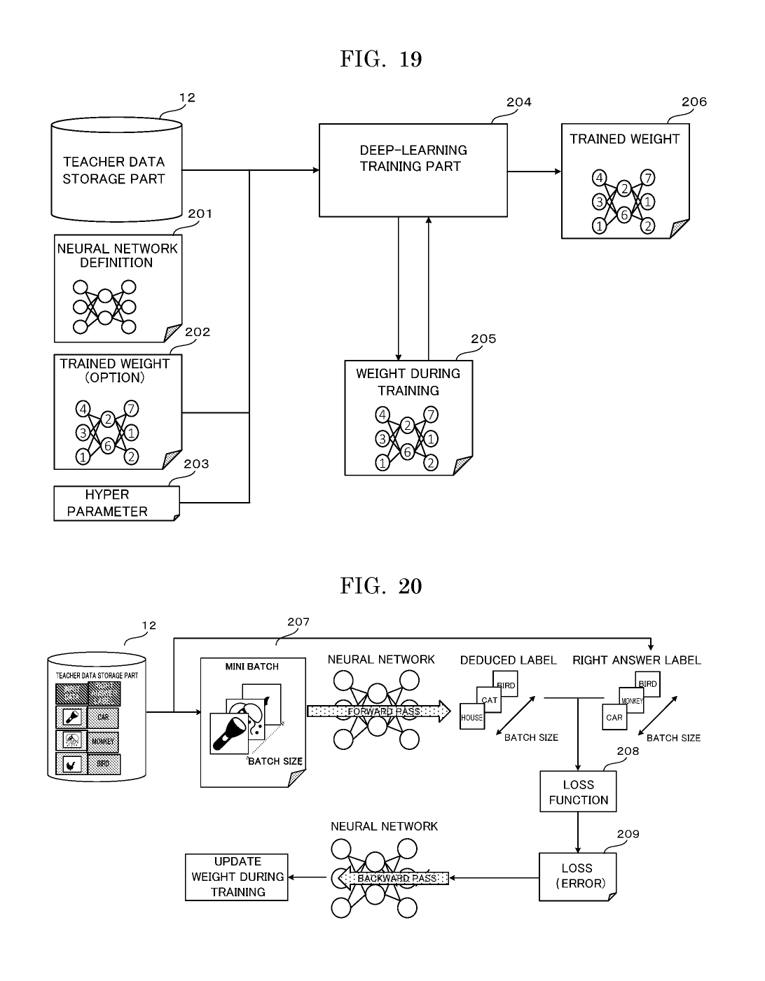

FIG. 19 is a block diagram illustrating an example of the entire training part. FIG. 20 is a block diagram illustrating another example of the entire training part.

Training using teacher data generated by the teacher data generation apparatus can be performed in the same manner as ordinary deep learning training.

Teacher data, which is generated by the teacher data generation apparatus 60 as a set of input data (image) and a right answer label, is stored in a teacher data storage part 12 illustrated in FIG. 19.

A neural network definition 201 is a file defining the type of a multi-layered neural network (deep neural network) and the structure representing in what state many neurons are connected with each other. The neural network definition 201 is a value specified by an operator.

A trained weight 206 is a value specified by an operator. It is a common practice to previously feed a trained weight before starting training. The trained weight 202 is a file storing the weight of each neuron of the neural network. The trained weight is not indispensable for training.

A hyper parameter 203 is a group of parameters relating to training. The hyper parameter 203 is a file storing, for example, how many times to perform training, and at what interval to update a weight during training.

A weight during training 205 indicates the weight of each neuron of the neural network during training, and is updated by training.

As illustrated in FIG. 20, a deep-learning training part 204 is configured to receive teacher data in a unit called mini batch 207 from the teacher data storage part 12. This teacher data is split into input data and a right answer label and passed forward and backward, to thereby update the weight during training and output a trained weight.

The condition for terminating training is input to the neural network, or whether or not to terminate training is determined by whether or not a loss function 208 has fallen below a threshold.

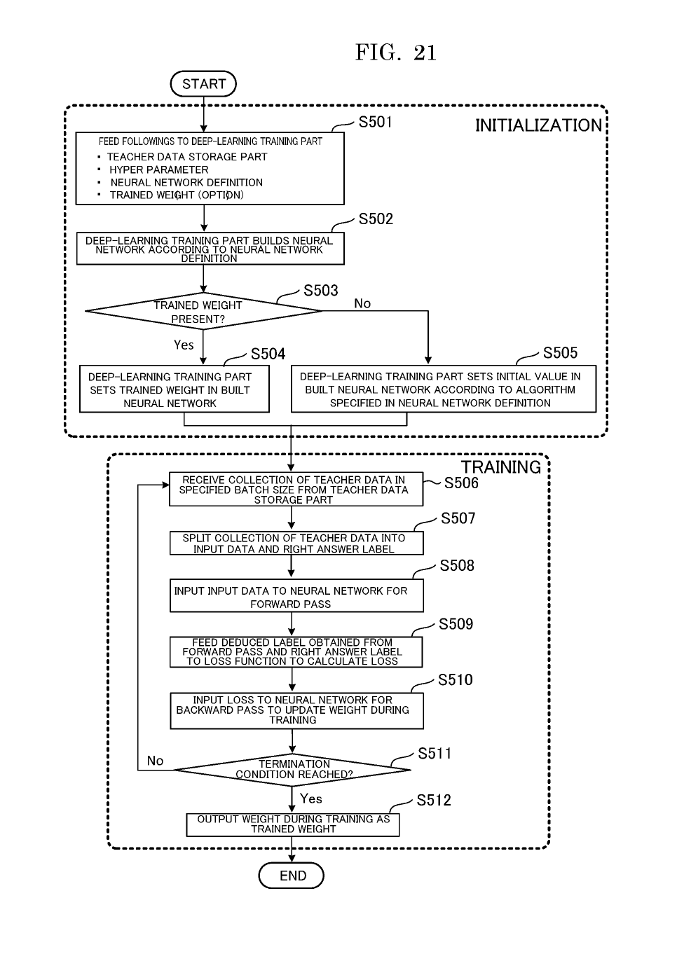

FIG. 21 is a flowchart illustrating an example of a flow of processes of the entire training part. The flow of processes of the entire training part will be described below with reference to FIG. 19 and FIG. 20.

In the step S501, an operator or software feeds the teacher data storage part 12, the neural network definition 201, and the hyper parameter 203, and as needed, the trained weight 202 to the deep-learning training part 204. Then, the flow moves to the step S502.

In the step S502, the deep-learning training part 204 builds up a neural network according to the neural network definition 201. Then, the flow moves to the step S503.

In the step S503, the deep-learning training part 204 determines whether or not the deep-learning training part 204 has the trained weight 202.

When the deep-learning training part 204 determines that the deep-learning training part 204 does not have the trained weight 202, the deep-learning training part 204 sets an initial value in the built neural network according to an algorithm specified in the neural network definition 201. Then, the flow moves to the step S506. On the other hand, when the deep-learning training part 204 determines that the deep-learning training part 204 has the trained weight 202, the deep-learning training part 204 sets the trained weight 202 in the built neural network. Then, the flow moves to the step S506. The initial value is described in the neural network definition 201.

In the step S506, the deep-learning training part 204 receives a collection of teacher data in a specified batch size from the teacher data storage part 12. Then, the flow moves to the step S507.

In the step S507, the deep-learning training part 204 splits the collection of teacher data into “input data” and a “right answer label”. Then, the flow moves to the step S508.

In the step S508, the deep-learning training part 204 inputs the “input data” to the neural network for the forward pass. Then, the flow moves to the step S509.

In the step S509, the deep-learning training part 204 feeds a “deduced label” obtained as a result of the forward pass and the “right answer label” to the loss function 208 to calculate a loss 209. Then, the flow moves to the step S510. The loss function 208 is described in the neural network definition 201.

In the step S510, the deep-learning training part 204 inputs the loss 209 to the neural network for the backward pass to update a weight during training. Then, the flow moves to the step S511.

In the step S511, the deep-learning training part 204 determines whether or not the condition for termination has been reached. When the deep-learning training part 204 determines that the condition for termination has not been reached, the flow returns to the step S506. When the deep-learning training part 204 determines that the condition for termination has been reached, the flow moves to the step S512. The condition for termination is described in the hyper parameter 203.

In the step S512, the deep-learning training part 204 outputs the weight during training 205 as a trained weight 206. Then, the flow ends.

<Deduction Part>

The deduction part 300 performs deduction (test) using the trained weight obtained by the training part 200.

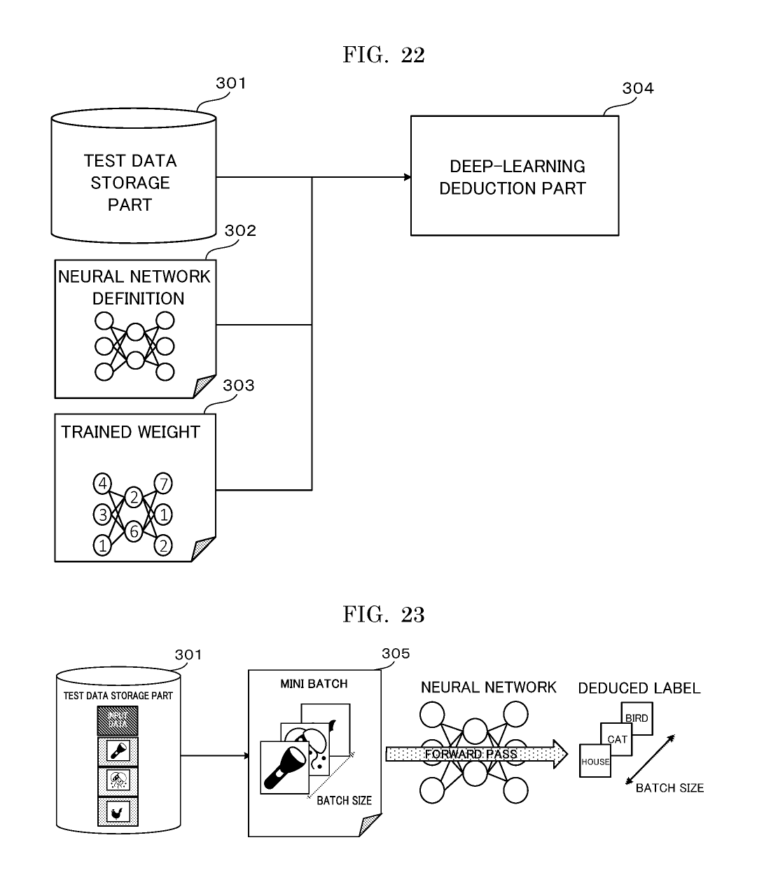

FIG. 22 is a block diagram illustrating an example of the entire deduction part. FIG. 23 is a block diagram illustrating another example of the entire deduction part.

Deduction using a test data storage part 301 can be performed in the same manner as ordinary deep learning deduction.

The test data storage part 301 is configured to store test data for deduction. The test data includes only input data (image).

A neural network definition 302 has the same basic structure as that of the neural network definition 201 of the training part 200.

A trained weight 303 is indispensably fed to deduction, because deduction is for evaluating the achievement of the training.

A deep-learning deduction part 304 corresponds to the deep-learning training part 204 of the training part 200.

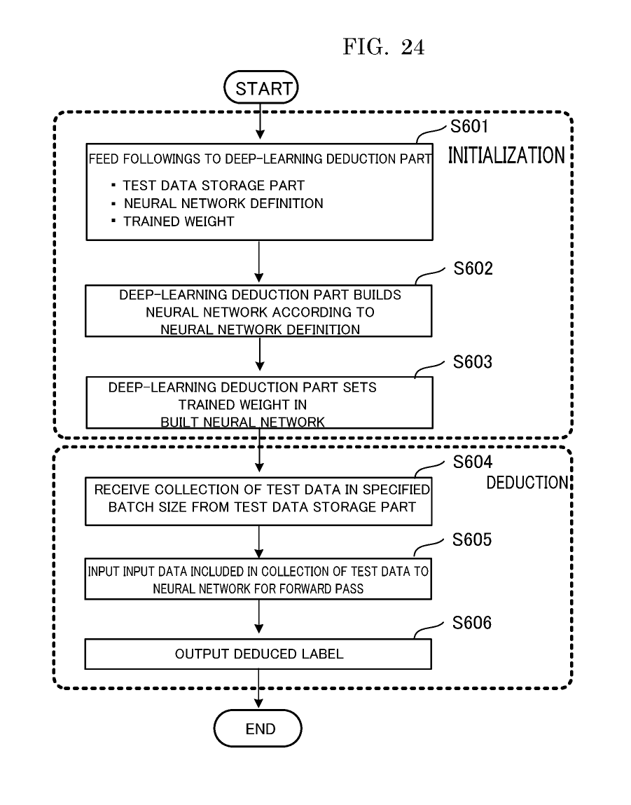

FIG. 24 is a flowchart illustrating an example of a flow of processes of the entire deduction part. The flow of processes of the entire deduction part will be described below with reference to FIG. 22 and FIG. 23.

In the step S601, an operator or software feeds the test data storage part 301, the neural network definition 302, and the trained weight 303 to the deep-learning deduction part 304. Then, the flow moves to the step S602.

In the step S602, the deep-learning deduction part 304 builds up a neural network according to the neural network definition 302. Then, the flow moves to the step S603.

In the step S603, the deep-learning deduction part 304 sets the trained weight 303 in the built neural network. Then, the flow moves to the step S604.

In the step S604, the deep-learning deduction part 304 receives a collection of test data in a specified batch size from the test data storage part 301. Then, the flow moves to the step S605.

In the step S605, the deep-learning deduction part 304 inputs the input data included in the collection of test data to the neural network for the forward pass. Then, the flow moves to the step S606.

In the step S606, the deep-learning deduction part 304 outputs a deduced label (a deduction result). Then, the flow ends.

What is claimed is:

1. A teacher data generation apparatus configured to generate teacher data used for object detection for detecting a specific identifying target, the teacher data generation apparatus comprising a processor configured to execute a process, the process comprising:
learning the specific identifying target by an object recognition method using reference data including the specific identifying target to generate an identification model of the specific identifying target; and
detecting the specific identifying target from moving image data including the specific identifying target based on deduction by the object recognition method using the generated identification model to generate teacher data for the specific identifying target.

2. The teacher data generation apparatus according to claim 1, wherein the process further comprises:
converting moving image data including the specific identifying target into a plurality of still image data and affixing a plurality of labels to regions of the specific identifying target to generate the reference data including the specific identifying target, the regions being cut out from the plurality of still image data obtained by the converting.

3. The teacher data generation apparatus according to claim 1, wherein the process further comprises:
selecting arbitrary teacher data from the generated teacher data for the specific identifying target.

4. The teacher data generation apparatus according to claim 1, wherein the object recognition method is performed by an object recognition method by using deep learning.

5. A teacher data generation method for generating teacher data used for object detection for detecting a specific identifying target, the teacher data generation method comprising:
learning the specific identifying target by an object recognition method using reference data including the specific identifying target to generate an identification model of the specific identifying target, by a processor; and
detecting the specific identifying target from moving image data including the specific identifying target based on deduction by the object recognition method using the generated identification model to generate teacher data for the specific identifying target, by the processor.

6. The teacher data generation method according to claim 5, further comprising:
converting moving image data including the specific identifying target into a plurality of still image data and affixing a plurality of labels to regions of the specific identifying target to generate the reference data including the specific identifying target, by the processor, the regions being cut out from the plurality of still image data obtained by the converting.

7. The teacher data generation method according to claim 5, further comprising:
selecting arbitrary teacher data from the generated teacher data for the specific identifying target, by the processor.

8. The teacher data generation method according to claim 5, wherein the object recognition method is performed by an object recognition method by using deep learning.

9. A non-transitory computer-readable recording medium having stored therein a teacher data generation program for generating teacher data used for object detection for detecting a specific identifying target, the teacher data generation program causing a computer to execute a process, the process comprising:
learning the specific identifying target by an object recognition method using reference data including the specific identifying target to generate an identification model of the specific identifying target; and
detecting the specific identifying target from moving image data including the specific identifying target based on deduction by the object recognition method using the generated identification model to generate teacher data for the specific identifying target.

10. The non-transitory computer-readable recording medium according to claim 9, wherein the process further comprises:
converting moving image data including the specific identifying target into a plurality of still image data and affixing a plurality of labels to regions of the specific identifying target to generate the reference data including the specific identifying target, the regions being cut out from the plurality of still image data obtained by the converting.

11. The non-transitory computer-readable recording medium according to claim 9, wherein the process further comprises:
selecting arbitrary teacher data from the generated teacher data for the specific identifying target.

12. The non-transitory computer-readable recording medium according to claim 9, wherein the object recognition method is performed by an object recognition method by using deep learning.
